(19) United States
(12) Patent Application Publication
(10) Pub. No.: US 2017/0281315 A1
(43) Pub. Date: Oct. 5, 2017

(54) REMOVABLE RAPID MAXILLARY EXPANDER

(71) Applicant: Tayside Health Board, Dundee (GB)

(72) Inventor: Evangelos Sotiropoulos, Dundee (GB)

(21) Appl. No.: 15/471,788

(22) Filed: Mar. 28, 2017

Related U.S. Application Data
(60) Provisional application No. 62/314,615, filed on Mar. 29, 2016.

(51) Int. Cl. A61C 7/10; A61C 7/02; A61C 19/02; A61C 9/00

(52) U.S. Cl. CPC A61C 7/10; A61C 9/00; A61C 7/023; A61C 19/02

(57) ABSTRACT

A maxillary arch expander, in particular an expander for use with a human patient, is described. Also described are a method of treatment that includes the use of the maxillary arch expander and a method of inserting and removing the maxillary arch expander from the mouth of the patient. All or part of the maxillary arch expander is generally easily removable and reinsertable during use.

### CROSS REFERENCE TO RELATED APPLICATIONS

This application claims priority to U.S. Provisional Application 62/314,615, filed Mar. 29, 2016, incorporated herein by reference in its entirety.

### FIELD

The present invention relates to a maxillary arch expander, in particular an expander for use with a human patient. All or part of the maxillary arch expander of the present invention is generally easily removable and reinsertable during use thereof. There is also provided a method of treatment comprising the use of the maxillary arch expander, and a method of inserting and removing the maxillary arch expander from the mouth of the patient.

### BACKGROUND

Rapid maxillary expander (RME) devices are well known. Known devices generally include the use of orthodontic bands on at least four teeth, 2 on either side of the jaw of the patient. A mid-arch expander is positioned between the orthodontic bands and secured thereto. The mid-arch expander is a skeletal type of expansion that involves the separation of the mid-palatal suture and movement of the maxillary shelves away from each other.

Known RME devices are not temporarily removable meaning that cannot be easily removed by medical practitioners during a medical emergency to allow clear access to a patient's wind pipe.

U.S. Pat. No. 5,769,631 discloses an orthodontic appliance having a mid-arch expander positioned between two forward orthodontic bands to effect inter-canine arch length development and bilateral spring-loaded telescopic rod and tube assemblies for molar destabilization and added arch length development in the mandibular or maxillary bicuspid area.

US2008/0003535 provides a maxillary arch expander which includes a transparent mouthpiece which fits over the teeth.

WO2012/091682 provides an orthodontic expander a middle part fixed in the mid-palatal area and two lateral parts responsible for lateral movement.

There exists a need for a rapid maxillary expander (RME) device which can be temporarily removed. A need also exists for a RME device which covers a relatively small proportion of the surface of the teeth of the patient, enhancing hygiene and periodontal health and minimizing food traps around the bonded teeth.

### SUMMARY OF THE INVENTION

In light of the foregoing, the present teachings provide apparatus and methods for expanding the maxillary arch of a patient.

According to a first aspect of the present invention there is provided a maxillary arch expander comprising:
a first outer portion adapted to be affixed to the teeth on one side of the jaw,
a second outer portion adapted to be affixed to the teeth on the other side of the jaw,
an expanding portion provided between the first outer portion and the second outer portion, movable between a retracted position and an extended position wherein the expanding portion is releasably affixable to the first outer portion and the second outer portion, and following detachment of the expanding portion from the first outer portion and the second outer portion the expanding portion is releasably reaffixable to the first outer portion and the second outer portion.

According to a further aspect of the present invention there is provided a maxillary arch expander comprising:
a first outer portion adapted to be affixed to the teeth on one side of the jaw,
a second outer portion adapted to be affixed to the teeth on the other side of the jaw,
an expanding portion provided between the first outer portion and the second outer portion, movable between a retracted position and an extended position wherein the expanding portion is affixable to the first outer portion and the second outer portion, wherein the first and second outer portions cover only the palatal surface of any tooth to which the first and second outer portions are affixed.

There is also provided a method of inserting the maxillary arch expander of the present invention into the mouth of a patient comprising: providing an impression of the teeth of the patient, providing the first and second outer portion manufactured to accommodate the teeth of the patient, affixing the first and second outer portions to the teeth of the patient, providing the expanding portion in the retracted position, and extending the expanding portion until it abuts the first and second outer portions, releasably securing the expanding portion to the first and second outer portions.

There is also provided a method of removing the maxillary arch expander of the present invention from the mouth of a patient comprising: detaching the expanding portion from the first and second outer portions (typically with the use of a tool), retracting the expanding portion until it no longer abuts the first and second outer portions, removing the expanding portion from the mouth of the patient.

The method may include the step of reaffixing the expanding portion to the first and second outer portions.

There is also provided a method of expanding the maxillary arch of a patient including the steps of: inserting the maxillary arch expander of the present invention into the mouth of the patient according to the method detailed herein, moving the expanding portion towards the extended position to expand the maxillary arch.

There is also provided a kit of parts comprising the first and second outer portions and the expanding portion and instructions for use.

The foregoing as well as other features and advantages of the present teachings will be more fully understood from the following description, Examples and Claims.

### DETAILED DESCRIPTION

The expander of the present invention includes two outer portions, affixable to the teeth on either side of the jaw of a patient, and an expanding portion provided between the outer portions. The expanding portion is releasably affixable to the outer portions, meaning that the expanding portion may be temporarily removed from the mouth of the patient. Following removal, the expanding portion may be reinserted into the mouth of the patient and may be reaffixed to the outer portions.

The expanding portion is movable relative to the outer portions, wherein in the retracted position, the expanding portion is relatively distant from one or both of the outer portions, and in the extended position, the expanding portion is biased against both outer portions, pushing the first and second outer portions away from each other. Selective movement of the expanding member towards the extended position causes the first and second outer portions to be moved away from each other, together with the teeth to which they are attached.

The expanding portion of the maxillary arch expander of the present invention may be temporarily removed in the event of an emergency, allowing clear access to the windpipe. Temporary removal of the expanding portion during treatment allows repair and/or cleaning of the expanding portion without removal of the tooth contacting outer portions.

Generally following rapid expansion of the maxillary arch of the patient, fixed orthodontic archwire (also known as braces) is fitted onto the teeth of the patient for several weeks, months or years to align the teeth of the upper jaw during the orthodontic treatment. It is common for RMEs to get debonded before the end of the orthodontic treatment with braces and in certain circumstances the fitting of an orthodontic retainer is required immediately after the RME debond in order for the midpalatal suture to be retained formed. Orthodontic retainers must be custom made to fit the mouth of each patient and may take several days or weeks for them to be produced or fitted and the patient's mouth is therefore left without the RME in situ or fixed braces for several days or weeks at the point in time when the midpalatal suture is likely to relapse. In order to take an impression of the mouth of a patient, standard rapid maxillary expanders must be removed.

In contrast, the expander of the present invention allows temporary removal of the expanding portion, allowing a mould of the patient's mouth to be taken for production of the braces. The expanding portion can then refitted into the patient's mouth through reaffixment of the expanding portion onto the first and second outer portions. The expander can ensure that the expansion of the maxillary arch is retained, and the periodontal structure is stabilised until the customised orthodontic retainer is available.

The first and second outer portions generally include at least one tooth covering to which the expanding portion is releasably affixable. Generally the first outer portion and the second outer portion both include two tooth covers, typically adapted to accommodate a premolar and a molar of the patient.

The expanding portion may include two arms releasably affixable to the first outer portion and two arms releasably affixable to the second outer portion. According to one embodiment, the expanding portion is releasably affixable to two tooth coverings on each side of the jaw of the patient. Generally, the expanding portion includes two arms releasably affixable to the tooth coverings of the first outer portion on one side of the patient's jaw, and two arms releasably affixable to the tooth coverings of the second outer portion on the other side of the patient's jaw.

According to one embodiment, each of the first and second outer portions includes two affixment points, one on each tooth covering. Alternatively, each of the first and second outer portions includes eight affixment points, two one each tooth covering; for instance one “male affixment point and one female affixment point on each tooth covering.

In particular, the expanding portion may include at least two arms, the first arm being releasably affixable to the tooth covering of the first outer portion and the second arm being releasably affixable to the tooth covering of the second outer portion. The tooth coverings generally include a receiving portion (generally an aperture) to accommodate the arms of the expanding portion. The receiving portions are suitably each at least 0.5 mm deep, typically around 1 mm deep. However the dimensions are largely dependent on the attachment used.

The receiving portions suitably do not extend entirely through the tooth covering, typically extending less than 75% through the thickness of the tooth covering. There is generally at least 1 mm material between the trough of the receiving portion and the tooth contacting side of the tooth covering.

During use, the expanding portion would not generally contact any tooth in the mouth of the patient. Such contact may exert too great a pressure on a tooth, increasing the risk of damage thereto.

According to one embodiment, the arms of the expanding portion may have square, pentagonal or hexagonal cross section, in particular towards the end facing the outer portions. This end of the arms of the expanding portion is to be accommodated in the receiving portion, and the aperture of the receiving portion generally has an equivalently shaped cross-section. A square, pentagonal or hexagonal cross section reduces the risk of rotational slippage following accommodation of the arm into the aperture.

According to one embodiment, the arms of the expanding portion may have a circular or oval cross section, and this may optionally be used in combination with a securement mechanism, for instance a screw mechanism.

Advantageously, each arm of the expanding portion has a hexagonal cross-section, and each aperture of the tooth coverings adapted to accommodate the arm has a hexagonal cross-section.

The receiving portion may include a slot, typically having a graduated depth, and terminating in an aperture to allow gradual insertion of the arm. In use, the slot may be horizontally provided on the tooth covering. In particular, the slot may be “L” shaped with the aperture provided at the end of the horizontal portion. Such embodiments may reduce the risk of vertical slippage of the arm of the expanding portion during or following insertion.

The receiving portion may include a flexible or biased mechanism (typically spring loaded) for securing the arm of the expanding portion in the receiving portion following affixment to the outer portions.

The apparatus of the present invention generally obviates the need for soldering to affix the arms of the expanding portion to the tooth coverings. This reduces the release of metal ions into the saliva of the patient which may potentially be harmful.

According to a further embodiment, the receiving portion may be affixed to the outer portion through, for instance, adhesive, solder or welding (including laser welding). The side walls of the receiving portion may slope inwardly to reduce the risk of inadvertent detachment of the arm of the expanding portion from the receiving portion. Generally the side walls of the receiving portion slope outwardly, before sloping inwardly.

The side walls of the receiving portion may include one or more slots or grooves to ease insertion of the end of the arm. Generally two to five slots or grooves are provided on the side walls of the receiving portions, typically four.

The arm may be secured to the receiving portion following insertion therein, for instance with a screw, bolt or safety clip.

The cross section of the receiving portion may be circular or oval. Generally the perimeter of the cross-section of the receiving portion includes one or more straight sections.

The arm may include a radially extending lip at its end.

The maxillary arch expander of the present invention is suitable for use with standard orthodontic bands. However, suitably the outer portions abut the palatal surface of the teeth to which they are affixed, and generally the outer portions extend 60% or less around the diameter of each tooth to which they are affixed. Typically the outer portions cover less than half of the lateral surface (above the gum line) of each tooth to which they are affixed, generally 25 to 50%.

According to one embodiment, the outer portions contact substantially exclusively or exclusively abut the palatal surface of the teeth to which they are affixed. Generally the outer portions do not contact the buccal or proximal surfaces of the teeth to which they are attached.

Less tooth coverage allows more effective cleaning during the maxillary expansion treatment. Mouth hygiene is improved compared to the use of standard orthodontic bands to deliver improved periodontal health during treatment. The apparatus of the present invention obviates the need for orthodontic bands to be fitted, or removed meaning that two less appointments are required.

According to one embodiment, the outer portions cover 20 to 60% of the lateral surface of each tooth to which they are affixed, generally 25 to 50%.

Generally the outer portions extend 40 to 50% around the diameter of each tooth to which they are affixed.

Each outer portion may include a bar or rod connecting the tooth coverings. This improves the structural stability of the maxillary arch expander during use and promotes expansion of the maxillary arch of the patient towards the front and back of the mouth.

According to one embodiment, each tooth covering may be in the form of a socketed cup adapted to accommodate the inward facing surface of a tooth. Each tooth covering may have an associated average thickness of more than 3 mm at the surface to accommodate the inward facing surface of the tooth, generally 3 to 7 mm, typically around 5 mm.

Generally outer portions will be affixed to the teeth with use of an adhesive.

According to one embodiment, the first and second outer portions extend less than 1 cm from the surface of the teeth of the user. Accordingly, the first and second outer portions may comfortably remain in place after temporary removal of the expanding portion, for instance for repair or cleaning.

The expander of the present invention may be formed from any suitable material. Particular mention may be made of cobalt-chrome and stainless steel.

The expanding portion is movable between the retracted and extended positions through any suitable means. Mention may be made of an expandable screw.

In the retracted position, the expanding portion would not be long enough to extend from one side of the patient's jaw to the other side of the patient's jaw. In the retracted position, the expanding portion would not abut both outer portions. Generally the expanding portion would be at least 2 mm shorter than the distance between the first and second outer portions in the retracted position.

At each incremental adjustment of the expanding portion, the expanding portion may be lockable.

### Method

According to an aspect of the present invention, there is provided a method of inserting the maxillary arch expander of the present invention into the mouth of a patient comprising:
a. providing an impression of the teeth of the patient,
b. providing the first and second outer portion manufactured to accommodate the teeth of the patient,
c. affixing the first and second outer portions to the teeth of the patient,
d. providing the expanding portion in the retracted position, and extending the expanding portion until it abuts the first and second outer portions,
e. releasably securing the expanding portion to the first and second outer portions.

An impression of the teeth of the patient may be provided through any suitable method. Particular mention may be made of the use of an alginate or silicon impression.

As noted above, the first and second outer portions generally each comprise two tooth coverings, typically in form of socketed cups to be placed on the inward facing surfaces of the teeth. Following placement of the tooth coverings on the teeth of the patient, a rod or bar may be affixed to the tooth coverings on each side of the patient's jaw. The rod or bar is generally non-releasably attached, suitably through the use of solder or laser welder.

During insertion, the expanding portion is provided in the retracted position, in which the length of the extending portion is less than the distance between the first and second outer portions (generally at least 2 mm less).

The expanding portion is moved towards the extended position until the expanding portion abuts the first and second outer portions. Typically the expanding portion is then expanded until it is releasably affixed to the first and second outer portions, generally being accommodated within the receiving portions (such as apertures) of the tooth coverings. Expansion of the expanding portion from abutment with the first and second outer portions to accommodation within the receiving portions is generally around 1 to 3 mm, suitably around 2 mm.

There is also provided a method of removing the maxillary arch expander of the present invention from the mouth of a patient comprising:
detaching the expanding portion from the first and second outer portions,
retracting the expanding portion until it no longer abuts the first and second outer portions,
removing the expanding portion from the mouth of the patient.

The expanding portion may be detached from the first and second outer portions with the use of a tool, for instance a key such as a screw key adapted to cooperate with a screw provided in the expanding portion, or in each of the outer portions.

The expanding portion may be movable between the retracted position towards the expanding position through the use of a tool, for instance a screw or hex key adapted to cooperate with a screw mechanism provided on the expanding portion to allow movement towards the expanding position, or towards the retracted position, suitably in increments.

Following temporary removal of the expanding portion, the first and second outer portion generally remain within the mouth of the patient. To promote comfort of the patient, the first and second outer portions do not generally extend more than 1 cm from the surface of the patient's teeth, typically 0.7 cm or less.

The expanding portion may be reaffixed to the first and second outer portions, suitably through steps d and e of the method of inserting described herein.

Alternatively the method may include the step of removing the first and second outer portions from the mouth of the user.

There is also provided a method of expanding the maxillary arch of a patient including the steps of:
inserting the maxillary arch expander of the present invention into the mouth of the patient according to the method detailed herein
moving the expanding portion towards the extended position to expand the maxillary arch.

The patient is typically a mammal, in particular a human.

Generally the expanding portion is moved towards the extended position in increments of 1 to 5 mm per week.

The duration of the expansion procedure depends on several factors including the expansion required and the age of the patient. Typical courses of treatment last one to three months.

Towards or at the end of the expansion of the patient's maxillary arch, the expanding portion of the apparatus of the present invention may be removed, allowing an impression of the patient's mouth to be taken for molding of a retainer. The expanding portion can then be reaffixed to retain the expansion of the patient's maxillary arch while the retainer is manufactured.

The method of expanding the maxillary arch may include:
removing the expanding portion of the expander of the present invention from the mouth of the patient,
taking an impression of the mouth of the patient,
reaffixing the expanding portion to the first and second outer portions,
producing a retainer from the impression.

### Kit of Parts

According to a further aspect of the present invention there is provided a kit of parts comprising the first and second outer portions and the expanding portion and instructions for use. The kit generally also comprises a tool suitable for detaching the expanding portion from the first and second outer portions following insertion of the maxillary arch expander of the present invention into the mouth of a patient.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

Throughout the description and claims of this specification, the words “comprise” and “contain” and variations of the words, for example “comprising” and “comprises”, mean “including but not limited to”, and are not intended to (and do not) exclude other moieties, additives, components, integers or steps. All documents referred to herein are incorporated by reference.

The use of the terms “include,” “includes”, “including,” “have,” “has,” or “having” should be generally understood as open-ended and non-limiting unless specifically stated otherwise.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10% variation from the nominal value unless otherwise indicated or inferred.

It should be understood that the order of steps or order for performing certain actions is immaterial so long as the present teachings remain operable. Moreover, two or more steps or actions may be conducted simultaneously.

### BRIEF DESCRIPTION OF THE DRAWINGS

To enable the present invention to be easily understood and readily practiced, the present invention will now be described for purposes of illustration and not limitation, in connection with the following figures wherein:

FIG. 1 shows a perspective view of an extender according to one embodiment of the present invention.

FIG. 2 shows a perspective view of an extender according to one embodiment of the present invention following removal of the expanding portion from the first and second outer portions.

FIG. 3 shows an alginate mound of the teeth of the patient to allow customized first and second outer portions to be molded.

FIGS. 4A and 4B show a top view and a cross-section respectively of one embodiment of an arm of the expanding portion and the corresponding receiving portion of the tooth covering.

FIGS. 5A and 5B show a top view and a cross-section respectively of one embodiment of an arm of the expanding portion and the corresponding receiving portion of the tooth covering.

FIGS. 6A and 6B show a top view and a cross-section respectively of one embodiment of an arm of the expanding portion and the corresponding receiving portion of the tooth covering.

FIGS. 7A and 7B show a top view and a cross-section respectively of one embodiment of an arm of the expanding portion and the corresponding receiving portion of the tooth covering.

It should be understood that the drawings described below are for illustration purposes only. Like numerals generally refer to like parts. The drawings are not necessarily to scale, with emphasis generally being placed upon illustrating the principles of the present teachings. The drawings are not intended to limit the scope of the present teachings in any way.

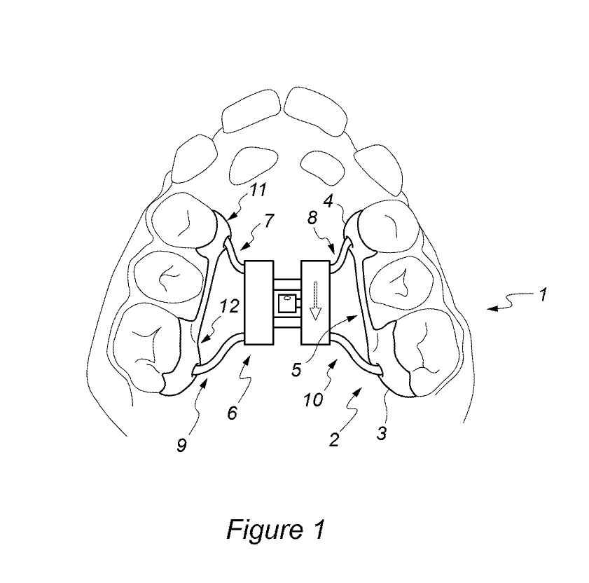

FIG. 1 is a perspective view of an extender, 1 according to an embodiment of the present invention. The first outer portion, 2 includes two tooth coverings, 3, 4 connected by a metal bar, 5. According to some embodiments of the present invention, the tooth coverings are not connected by a metal bar. The tooth coverings, 3, 4 abut the inward facing surface of a canine and a molar of the patient. Each tooth, 3, 4 covering extends approximately 20 to 30% around the diameter of the tooth it abuts and covers 25 to 30% of the lateral surface of the tooth it abuts. Each tooth covering includes an aperture which extends around 75% through the thickness of the tooth covering.

The expander portion, 6 includes four arms, 7, 8, 9, 10 and each arm, 7, 8, 9, 10 is accommodated within the four apertures provided in the tooth coverings, 3, 4, 11, 12. Each arm, 7, 8, 9, 10 of the expander portion, 6 is releasably affixed to a tooth covering, 3, 4, 11, 12.

The expander portion, 6 is laterally movable within the mouth of a patient towards the two sides of the patient's jaw. The expander portion, 6 is movable between a retracted and an expanded position through expansion of a screw. Generally a 180 degree rotation of the screw is associated with a movement of 2 mm between the retracted and extended positions.

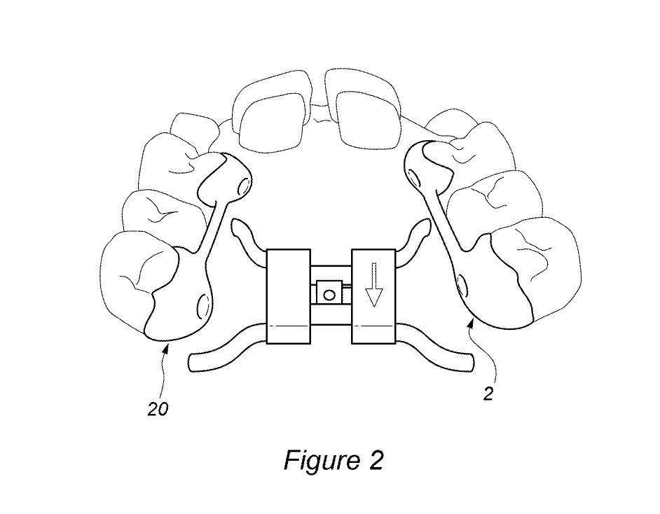

FIG. 2 shows a perspective view of an extender according to one embodiment of the present invention following removal of the expander portion, 6 from the first and second outer portions, 2, 20. The expander portion, 6 may be temporarily removed to allow cleaning or repair. The first and second outer portions, 2, 20 remain affixed to the teeth of the patient. The outer portions, 2, 20 do not significantly extend from the teeth of the patient providing comfort. The embodiment of FIG. 2 includes a metal bar connecting the tooth coverings on each side of the jaw. However, this metal bar is optional, and in some embodiments of the present invention the tooth coverings are not connected.

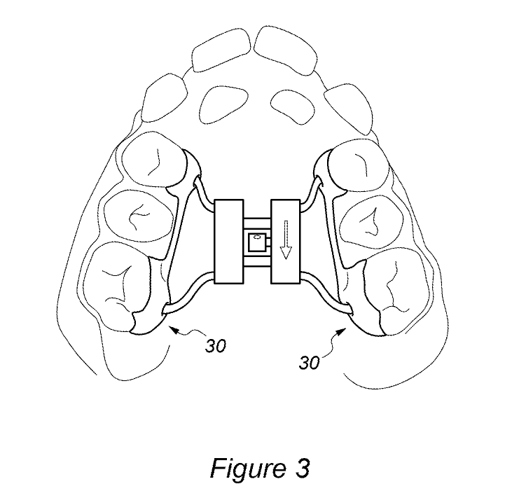

FIG. 3 shows a wax mound, 30 of the teeth of the patient to allow customized first and second outer portions to be molded. As noted above, the metal bar connecting the tooth coverings is not present in all embodiments of the present invention.

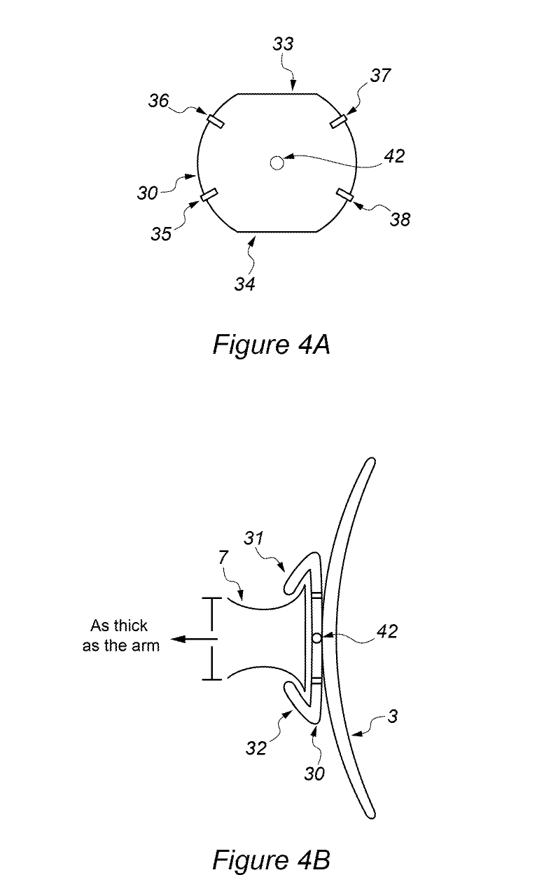

FIGS. 4A and 4B illustrates an embodiment where the receiving portion 30 is soldered to the tooth covering, 3 by a solder inset, 42. The side walls of the receiving portion, 31, 32 slope inwards to reduce the risk of inadvertent detachment of the arm, 7 of the expanding portion, 6 from the receiving portion, 30. The receiving portion, 30 is of generally circular cross-section but with two substantially straight sections, 33, 34, generally opposite each other to prevent the risk of rotational slippage. The arm, 7 has a similarly shaped cross section. Four grooves, 35, 36, 37 and 38 are incorporated on the side walls, 31, 32 of the receiving portion, 30 to facilitate insertion of the arm, 7. The arm, 7 narrows towards its end before radially extending to form a lip.

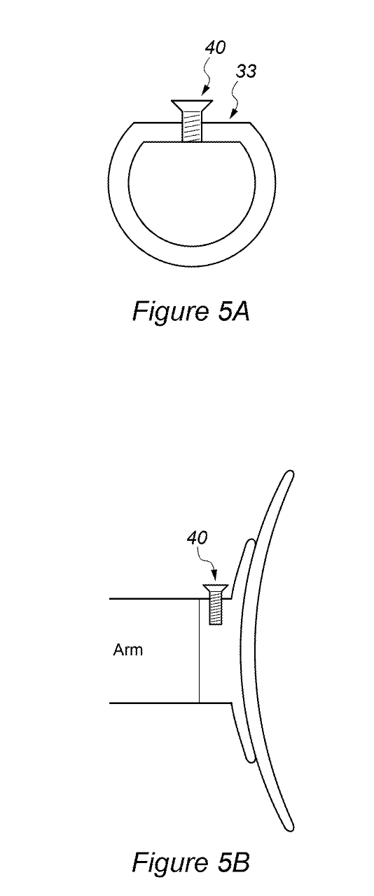

FIGS. 5A and 5B illustrate a further embodiment, similar to that illustrated in FIGS. 4A and 4B. The receiving portion, 30 is of generally circular cross section except with one straight section, 33. The arm, 7 has a similarly shaped cross section. There is provided a screw, 40 to secure the arm, 7 into the receiving portion, 30. The screw, 40 extends through the side wall, 31, 32 of the receiving portion, 30 into the arm, 7 at the straight section, 33.

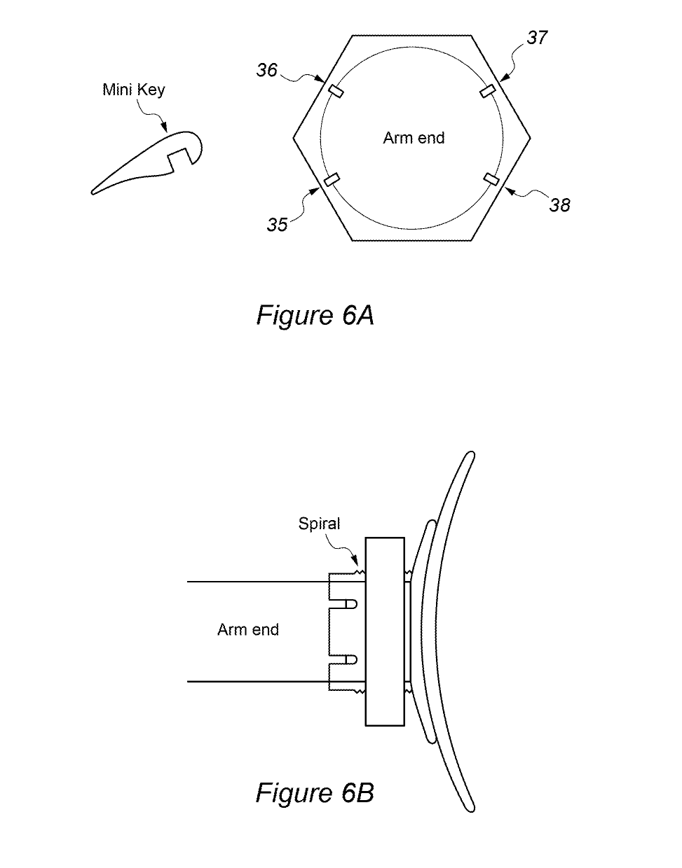

FIGS. 6A and 6B illustrate an embodiment where the receiving portion, 30, and arm, 7 are both of generally hexagonal cross-section. There is provided a locking bolt mechanism, 40 on the receiving portion, 30 which engages the end of the arm, 7 in the receiving portion, 30 once the locking bolt mechanism, 40 is fully screwed. A key or other tool may be required to disengage the locking bolt mechanism, 40.

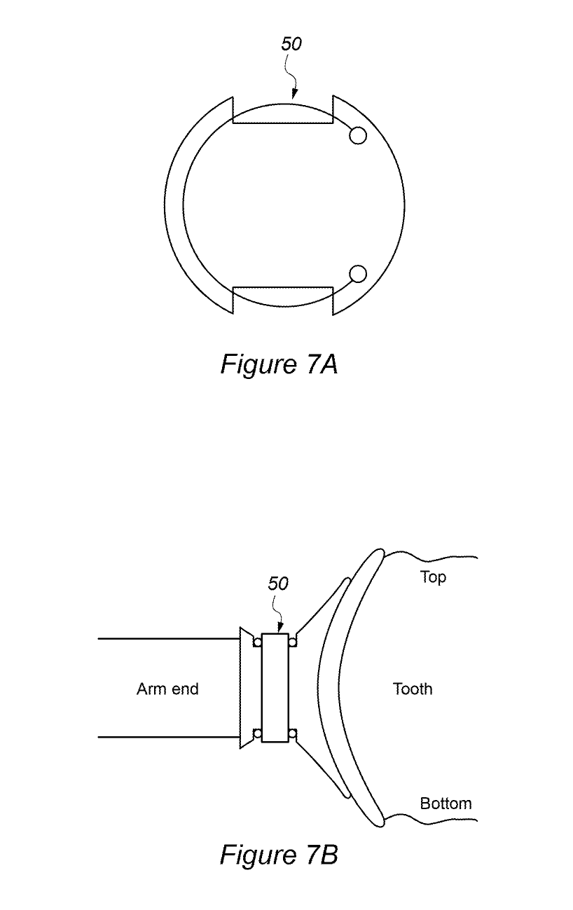

The embodiment illustrated in FIGS. 7A and 7B includes a safety clip, 50 provided in the receiving portion, 30 to secure the arm, 7 into the receiving portion, 30.

All numerical values provided incorporate 10% less than and 10% more than the numerical value provided.

Where appropriate, teaching relating to any aspect or embodiment may relate to any other embodiment.

Various modifications and variations of the described aspects of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes of carrying out the invention which are obvious to those skilled in the relevant fields are intended to be within the scope of the following claims.

What is claimed is:

1. A maxillary arch expander comprising:
a first outer portion adapted to be affixed to the teeth on one side of the jaw,
a second outer portion adapted to be affixed to the teeth on the other side of the jaw,
an expanding portion provided between the first outer portion and the second outer portion, movable between a retracted position and an extended position wherein the expanding portion is biased against the first outer portion and the second outer portion in the extended position,
wherein the expanding portion is releasably affixable to the first outer portion and the second outer portion, and following detachment of the expanding portion from the first outer portion and the second outer portion the expanding portion is releasably reaffixable to the first outer portion and the second outer portion.

2. The expander of claim 1 wherein the expanding portion includes two arms releasably affixable to the first outer portion and two arms releasably affixable to the second outer portion.

3. The expander of claim 2 wherein the first outer portion and the second outer portion both include two tooth coverings to which the arms of the expanding portion are releasably affixable.

4. The expander of claim 3 wherein the tooth coverings each include an aperture to accommodate an arm of the expanding portion.

5. The expander of claim 4 wherein each aperture extends no more than 75% through the thickness of the tooth covering.

6. The expander of claim 5 wherein the arms of the expanding portion have a square, pentagonal or hexagonal cross section.

7. The expander of claim 4 including a biased mechanism suitable for securing the arm of the expanding portion in the aperture.

8. The expander of claim 1 wherein the first outer portion and the second outer portion extend 60% or less around the diameter of each tooth to which they are affixed.

9. The expander of claim 1 wherein the first outer portion and the second outer portion cover 25 to 50% of the lateral surface (above the gum line) of each tooth to which they are affixed.

10. The expander of claim 1 wherein the first outer portion and the second outer portion have an associated thickness of 1 cm or less.

11. A maxillary arch expander comprising:
a first outer portion adapted to be affixed to the teeth on one side of the jaw,
a second outer portion adapted to be affixed to the teeth on the other side of the jaw,
an expanding portion provided between the first outer portion and the second outer portion, movable between a retracted position and an extended position wherein the expanding portion is affixable to the first outer portion and the second outer portion, wherein the first and second outer portions cover less than half of the lateral surface of any tooth to which the first and second outer portions are affixed.

12. The expander of claim 11 wherein the first and second outer portions abut the palatal surfaces of any tooth to which they are affixed, and the first and second outer portions do not contact the palatal or buccal surfaces of any tooth to which they are affixed.

13. A method of inserting the maxillary arch expander as claimed in claim 1 into the mouth of a patient comprising:
a) providing an impression of the teeth of the patient,
b) providing the first and second outer portion manufactured to accommodate the teeth of the patient,
c) affixing the first and second outer portions to the teeth of the patient,
d) providing the expanding portion in the retracted position, and extending the expanding portion until it abuts the first and second outer portions,
e) releasably securing the expanding portion to the first and second outer portions.

14. A method of removing the maxillary arch expander of the claim 1 from the mouth of a patient comprising:
detaching the expanding portion from the first and second outer portions,
retracting the expanding portion until it no longer abuts the first and second outer portions,
removing the expanding portion from the mouth of the patient.

15. A method of expanding the maxillary arch of a patient including the steps of:
inserting the maxillary arch expander of claim 1 into the mouth of the patient according to the method detailed herein,
moving the expanding portion towards the extended position to expand the maxillary arch.

16. The method as claimed in claim 14 including:
removing the expanding portion of the expander of the present invention from the mouth of the patient,
taking an impression of the mouth of the patient,
reaffixing the expanding portion to the first and second outer portions,
producing a retainer from the impression.

17. A kit of parts comprising the first and second outer portions and the expanding portion as claimed in claim 1 and instructions for use.
